(19) United States
(12) Patent Application Publication
(10) Pub. No.: US 2025/0230769 A1
(43) Pub. Date: Jul. 17, 2025

(54) Black-Start Achievable Energy Storage System and Method, Gas Turbine Generator Set, Mobile Power Generation Apparatus, and Fracturing System

(71) Applicant: YANTAI JEREH PETROLEUM EQUIPMENT & TECHNOLOGIES CO., LTD., Yantai (CN)

(72) Inventors: Ting ZHANG, Yantai (CN); Wanchun ZHA, Yantai (CN); Wangyu SUN, Yantai (CN); Huijuan CAO, Yantai (CN); Zhijie LIU, Yantai (CN); Qiong WU, Yantai (CN)

(73) Assignee: YANTAI JEREH PETROLEUM EQUIPMENT & TECHNOLOGIES CO., LTD., Yantai (CN)

(21) Appl. No.: 19/169,749

(22) Filed: Apr. 3, 2025

Related U.S. Application Data
(63) Continuation of application No. PCT/CN2024/077456, filed on Feb. 18, 2024.

(30) Foreign Application Priority Data
Mar. 9, 2023 (CN) 202310239283.4
May 22, 2023 (CN) 202321266806.6

(51) Int. Cl. F02C 6/00; E21B 43/26; F02C 7/24; F02C 7/26; H02J 7/00

(52) U.S. Cl. CPC F02C 6/00; F02C 7/24; F02C 7/26; H02J 7/0063; E21B 43/2607; F05D 2220/76; F05D 2260/85

(57) ABSTRACT

The present disclosure relates to the field of generator-set energy storage management technologies, and in particular, to a black-start achievable energy storage system and method, a gas turbine generator set, a mobile power generation apparatus, and a fracturing system. The energy storage system includes: an energy storage apparatus and a power conversion system (PCS), where the PCS is electrically connected to the energy storage apparatus, and configured to control, based on different scenario conditions, the energy storage apparatus to implement functions such as charging and discharging. In the present disclosure, through integration of the energy storage system and formulation of the energy storage method, the entire generator set has a black start capability, thereby improving production and working stability of the gas turbine generator set.

### CROSS-REFERENCE TO RELATED APPLICATIONS

This application is a continuation of and claims the benefit of priority to PCT Application No. PCT/CN2024/077456, filed Feb. 18, 2024, and entitled ENERGY STORAGE SYSTEM AND METHOD CAPABLE OF ACHIEVING BLACK START, GAS TURBINE GENERATOR SET, MOBILE POWER GENERATION DEVICE, AND FRACTURING SYSTEM, which is based on and claims the benefit of priority to Chinese Patent Application No. 202310239283.4, filed with the China National Intellectual Property Administration on Mar. 9, 2023 and entitled “BLACK-START ACHIEVABLE ENERGY STORAGE SYSTEM AND METHOD AND GAS TURBINE GENERATOR SET”, and Chinese Patent Application No. 202321266806.6, filed with the China National Intellectual Property Administration on May 22, 2023 and entitled “MOBILE POWER GENERATION APPARATUS AND FRACTURING SYSTEM.” The above applications are incorporated herein by reference in their entireties.

### TECHNICAL FIELD

The present disclosure relates to the field of generator-set energy storage management technologies, and in particular, to a black-start achievable energy storage system and method, a gas turbine generator set, a mobile power generation apparatus, and a fracturing system.

### BACKGROUND

In North American regions, hydraulic fracturing is gradually replaced with electric fracturing. In regions, such as the United States and Canada, in which natural gas is more easily available, a solution of generating power on site using natural gas as a fuel to drive an electric fracturing apparatus to perform fracturing operation is carried out increasingly. Gas turbine generator sets are increasingly favored in North American regions as products with high power density, stability, and transportation convenience. However, almost all gas turbine generator sets on the market require external power supply to be started, and most exhaust systems are located at gooseneck positions of trailers, resulting in improper weight layout of an entire vehicle and a high center of gravity. It is very inconvenient to go through procedures for transfinite transport in the states of the United States, and stability during traveling is also poor.

Cooperation between gas turbines and energy storage can better achieve a self-start (black start), and can achieve a good start and supply power externally well regardless of being at an oilfield well site with a power shortage, a disaster relief site, or the like. Currently, there are basically no energy storage system-integrated products/solutions on the market.

### SUMMARY

Embodiments of the present disclosure provide a black-start achievable energy storage system and method, a gas turbine generator set, a mobile power generation apparatus, and a fracturing system.

According to an aspect, the present disclosure provides a black-start achievable energy storage system, including: an energy storage apparatus and a power conversion system (PCS), where the PCS is electrically connected to the energy storage apparatus, and configured to control, based on different scenario conditions, the energy storage apparatus to implement functions such as charging and discharging.

Further, the energy storage system further includes: a transformer, configured to regulate a voltage difference between the energy storage system and an external apparatus.

In another aspect, the present disclosure provides a black-start achievable energy storage method, applicable to the foregoing energy storage system, including: the first control method, the second control method, the third control method, the fourth control method, and the fifth control method for achieving different scenario conditions.

The first control method includes: when the energy storage system supplies power to an internal power-consuming apparatus, supplying, by the energy storage apparatus, power to the internal power-consuming apparatus through the PCS; and when the internal power-consuming apparatus needs a higher voltage or a lower voltage, supplying, by the transformer, power to the internal power-consuming apparatus after performing regulation.

The second control method includes: when the energy storage system supplies power to an external apparatus, supplying, by the energy storage apparatus, power to the external apparatus through the PCS; and when the external apparatus needs a higher voltage or a lower voltage, supplying, by the transformer, power to the external apparatus after performing regulation.

The third control method includes: when both the energy storage system and a generator set supply power to an external apparatus, after a voltage generated by the energy storage apparatus is converted by the PCS and then regulated by the transformer to be consistent with a voltage generated by the generator set, connecting the energy storage system and the transformer in parallel through synchronization to supply power to the external apparatus.

The fourth control method includes: when the energy storage system is charged by a generator set, regulating, by the transformer, power generated by the generator set, and then, charging, by the PCS, the energy storage apparatus with the power.

The fifth control method includes: when an external power supply charges the energy storage system or supplies power to an internal apparatus, if the external power supply satisfies a requirement of the energy storage system/the internal apparatus, charging, by the external power supply, the energy storage system directly through the PCS or directly supplying, by the external power supply, power to the internal apparatus; and if the external power supply does not satisfy a requirement of the energy storage system/the internal apparatus, performing charging/power supply after regulation by the transformer.

The present disclosure finally further provides a gas turbine generator set, including the black-start achievable energy storage system as described above; or using the black-start achievable energy storage method as described above.

Further, the gas turbine generator set further includes: a control and power system 010, a gas turbine 020, a power generator 030, a silencing compartment and air inlet system 040, and an exhaust system 060.

Through the foregoing technical solutions, integration of the energy storage system allows the entire generator set to have a black start capability, so that the gas turbine can be started and transmit power externally without external power. When an abnormal shutdown occurs, no additional direct-current lubrication system or external power supply is needed to ensure normal operation of the lubrication system during shutdown of the gas turbine generator set. In addition, for a short period of time, the energy storage system may be used as power supplement for the gas turbine generator set, to supply power to an external power-consuming apparatus.

It should be noted that, the foregoing method can be entirely or partially stored on a computer-readable storage medium. The computer-readable storage medium may be packaged together with a processor of a controller, or may be packaged separately from the processor of the controller. This is not limited in the present disclosure.

The present disclosure discloses a mobile power generation apparatus and a fracturing system, to resolve a problem that the mobile power generation apparatus in the related art is prone to a failure in starting normally.

To resolve the foregoing technical problems, the following technical solutions are used in the present disclosure: A mobile power generation apparatus is provided, including a vehicle, where an energy storage device, a power generator, a gas turbine, and a starting mechanism for driving the gas turbine to work are arranged on the vehicle, the power generator is connected to the gas turbine, and the energy storage device is electrically connected to the starting mechanism to supply power to the starting mechanism.

A fracturing system is provided, including a load module and a power supply module, where the power supply module is electrically connected to the load module to supply power to the load module.

The technical solutions adopted in the present disclosure can achieve the following beneficial effects: In the present disclosure, because the energy storage device built in the mobile power generation apparatus can supply power to the starting mechanism for driving the gas turbine to work, it is ensured that the gas turbine can work normally. In other words, without an external power supply apparatus, the gas turbine can be normally started through the energy storage device. In addition, the gas turbine works normally and can also transmit power to the external power-consuming apparatus through the power generator. It can be learned that it avoids that the mobile power generation apparatus cannot be normally started due to a power shortage or power outage at a power consumption site, which, therefore, endows the mobile power generation apparatus with a black start capability. Therefore, the mobile power generation apparatus disclosed in the present disclosure can resolve a problem that the mobile power generation apparatus in the related art is prone to a failure in starting normally.

### BRIEF DESCRIPTION OF THE DRAWINGS

The accompanying drawings are used to provide further understanding of the technical solutions of the present disclosure, and constitute a part of the specification, which are used to explain the technical solutions of the present disclosure in combination with the embodiments of the present disclosure, and do not constitute a limitation to the technical solutions of the present disclosure.

FIG. 1 is an example diagram of power supply logic of a black-start achievable energy storage method according to an embodiment of the present disclosure.

FIG. 2 is an example structural layout diagram of a gas turbine generator set according to an embodiment of the present disclosure.

FIG. 3 is an example schematic diagram of power supply of an energy storage device according to an embodiment of the present disclosure.

FIG. 4 is an example schematic cross-sectional structural view of a mobile power generation apparatus according to an embodiment of the present disclosure.

FIG. 5 is an example schematic structural diagram of a first type of mobile power generation apparatus according to an embodiment of the present disclosure.

FIG. 6 is an example schematic structural diagram of a second type of mobile power generation apparatus according to an embodiment of the present disclosure.

### REFERENCE NUMERALS

control and power system 010, gas turbine 020, turbine air inlet 021, starting mechanism 022, combustion exhaust gas outlet 023, power generator 030, cooling air inlet 031, cooling air outlet 032, silencing compartment and air inlet system 040, radiator 050, exhaust system 060, silencer 061, vehicle 070, lubrication system and fuel system 071, and support mechanism 072;
100—vehicle;
200—compartment, 201—inner cavity, 202—first air inlet, 203—second air inlet, 204—third air inlet, 205—first air outlet, 206—second air outlet, 207—third air outlet, 210—power generator, 211—cooling air inlet, 212—cooling air outlet, 220—gas turbine, 221—gas inlet, 222—gas outlet, 230—starting mechanism, 240—connecting channel;
300—energy storage device, 310—battery, 320—PCS;
410—internal power-consuming component, 420—external power supply apparatus, 430—external power-consuming apparatus;
500—control and power system; 510—transformer;
600—exhaust system, 610—first exhaust pipe, 620—second exhaust pipe, 630—silencer, 631—first silencer, 632—second silencer, 633—guide portion, 634—third silencer, 640—arc-shaped curved pipe;
710—lubrication system, 720—fuel system, 730—radiator, 740—support mechanism.

### DETAILED DESCRIPTION

The following describes the technical solutions in the embodiments of the present disclosure with reference to the accompanying drawings in the embodiments of the present disclosure. Apparently, the described embodiments are merely some rather than all of the embodiments of the present disclosure. All other embodiments obtained by a person of ordinary skill in the art based on embodiments of the present disclosure without creative efforts shall fall within the protection scope of the present disclosure.

In the description of the present disclosure, it should be noted that, unless otherwise explicitly specified or defined, the terms, such as “connect” and “connection”, should be understood in a broad sense. For example, the connection may be a fixed connection, a detachable connection, or an integral connection. A person of ordinary skill in the art may understand the specific meanings of the foregoing terms in the present disclosure according to specific situations.

In embodiments of the present disclosure, the term “exemplarily” or “for example” is used to represent giving an example, an illustration, or a description. Any embodiment or design scheme described as an “exemplarily” or “for example” in embodiments of the present disclosure should not be explained as being more preferred or having more advantages than another embodiment or design scheme. Exactly, use of the term, such as “exemplarily” or “for example”, is intended to present a related concept in a specific manner.

Embodiments of the present disclosure provide a black-start achievable energy storage system and method and a gas turbine generator set.

According to an aspect, the present disclosure provides a black-start achievable energy storage system, including: an energy storage apparatus and a PCS, where the PCS is electrically connected to the energy storage apparatus, and configured to control, based on different scenario conditions, the energy storage apparatus to implement functions such as charging and discharging.

Further, the energy storage system further includes: a transformer, configured to regulate a voltage difference between the energy storage system and an external apparatus.

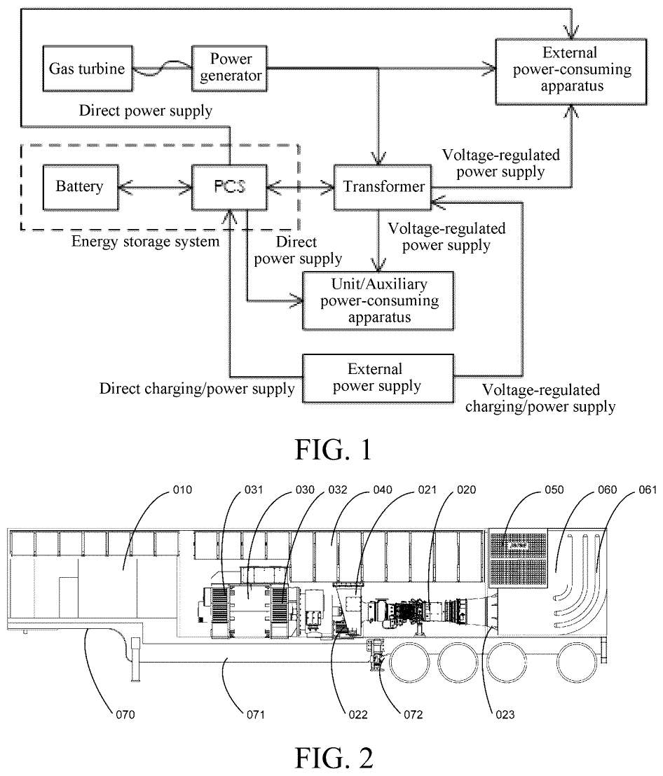

As shown in FIG. 1, according to another aspect, the present disclosure provides a black-start achievable energy storage method, applicable to the energy storage system, including: a first control method, a second control method, a third control method, a fourth control method, and a fifth control method for achieving different scenario conditions.

The first control method includes: when the energy storage system supplies power to an internal power-consuming apparatus, supplying, by the energy storage apparatus, power to the internal power-consuming apparatus through the PCS; and when the internal power-consuming apparatus needs a higher voltage or a lower voltage, supplying, by the transformer, power to the internal power-consuming apparatus after performing regulation.

The second control method includes: when the energy storage system supplies power to an external apparatus, supplying, by the energy storage apparatus, power to the external apparatus through the PCS; and when the external apparatus needs a higher voltage or a lower voltage, supplying, by the transformer, power to the external apparatus after performing regulation.

The third control method includes: when both the energy storage system and a generator set supply power to an external apparatus, after a voltage generated by the energy storage apparatus is converted by the PCS and then regulated by the transformer to be consistent with a voltage generated by the generator set, connecting the energy storage system and the transformer in parallel through synchronization to supply power to the external apparatus.

The fourth control method includes: when the energy storage system is charged by a generator set, regulating, by the transformer, power generated by the generator set, and then, charging, by the PCS, the energy storage apparatus with the power.

The fifth control method includes: when an external power supply charges the energy storage system or supplies power to an internal apparatus, if the external power supply satisfies a requirement of the energy storage system/the internal apparatus, charging, by the external power supply, the energy storage system directly through the PCS or directly supplying, by the external power supply, power to the internal apparatus; and if the external power supply does not satisfy a requirement of the energy storage system/the internal apparatus, performing charging/power supply after regulation by the transformer.

The present disclosure finally further provides a gas turbine generator set, including the black-start achievable energy storage system as described above; or using the black-start achievable energy storage method as described above.

Further, the gas turbine generator set further includes: a control and power system 010, a gas turbine 020, a power generator 030, a silencing compartment and air inlet system 040, and an exhaust system 060.

As shown in FIG. 2, the entire generator set mainly includes several parts such as a control and power system 010, a gas turbine 020, a power generator 030, a silencing compartment and air inlet system 040, an exhaust system 060, and a vehicle 070.

The gas turbine 020 is coupled to the power generator 030 and placed in the silencing compartment 040. Two ends of the gas turbine 020 are respectively a turbine air inlet 021 and a combustion exhaust gas outlet 023. The silencing compartment and air inlet system 040 is provided with an air inlet. A part of air is collected at the turbine air inlet 021 to provide combustion air to the gas turbine 020. Air after combustion is discharged through the combustion exhaust gas outlet 023, the combustion exhaust gas outlet 023 is connected to the exhaust system 060, and an exhaust airflow is changed from a horizontal direction to a vertical direction and discharged to an external environment.

At least one or more silencers 061 are arranged in the exhaust system 060 to reduce noise generated during operation of the gas turbine 020. In consideration of smoothness of a flow field, a bottom of the silencer 061 is designed into an arc form. During arrangement of one or more silencers 061, the plurality of silencers 061 are not arranged evenly.

071 is a component such as a lubrication system or a fuel system, and is arranged on two sides of the vehicle 070 or at some positions in the middle of a girder. 050 is a radiator, and configured to cool lubricant in the lubrication system. 072 is a support mechanism, configured to adjust a level of the entire generator set, and arranged on a side surface of the vehicle 070. The starting mechanism 022 is directly or indirectly coupled to the gas turbine 020 or the power generator 030, and configured to perform turning or start the generator set. A form of the starting mechanism 022 may be an electric or hydraulic starting mechanism.

In an embodiment, the power generator 030 is respectively provided with at least one cooling air inlet 031 and one cooling air outlet 032. The cooling air inlet 031 is connected to an air inlet provided on the silencing compartment and air inlet system 040. A fan built in the power generator 030 draws cooling air into the power generator for cooling. Air after cooling is discharged from the cooling air outlet 032. The cooling air outlet 032 is connected to an air vent on the silencing compartment 040. The air after cooling air inlet is directly discharged from the air vent to the external environment.

In another embodiment, the power generator 030 is respectively provided with at least one cooling air inlet 031 and one cooling air outlet 032. The cooling air inlet 031 is connected to an air inlet provided on the silencing compartment and air inlet system 040. A fan built in the power generator 030 draws cooling air into the power generator for cooling. Air after cooling is discharged from the cooling air outlet 032. The discharged air is mixed with air entering the compartment from the air inlet of the silencing compartment and air inlet system 040, continues to flow in the silencing compartment 040 toward the gas turbine 020, to cool the gas turbine 020 and related components, and is discharged to the external environment from an air outlet at a tail of the silencing compartment 040.

Through the foregoing technical solutions, for integration of the energy storage system, the present disclosure has at least the following advantages: Integration of the energy storage system allows the entire generator set to have a black start capability, so that the gas turbine can be started and transmit power externally without external power. When an abnormal shutdown occurs, no additional direct-current lubrication system or external power supply is needed to ensure normal operation of the lubrication system during shutdown of the generator set. In addition, for a short period of time, the energy storage system may be used as power supplement for the gas turbine generator set, to supply power to an external power-consuming apparatus.

Placing the exhaust system at a tail of a trailer makes weight layout more proper. In addition, if the exhaust system is placed at a tail of a trailer, without a height restriction on a gooseneck, an entire shaft system can be lowered, thereby lowering a center of gravity of the entire vehicle and improving traveling stability of the vehicle.

In terms of cooling of the power generator, regardless of a branch solution 1 or a branch solution 2, that the power generator directly draws air from outside the silencing compartment can lower a requirement of the silencing compartment for a ventilation volume, thereby lowering a requirement for fan selection.

A form of adding the silencer to an elbow of the exhaust system can reduce a size and a space requirement of the exhaust system to a larger extent, so that the entire generator set is more compact. The curvature of the bottom of the silencer can better guide an airflow, thereby reducing exhaust resistance of the gas turbine. In addition, uneven arrangement of the silencers can effectively adjust an airflow rate, which improves effects of noise reduction and resistance reduction to some extent.

It should be noted that, the foregoing method can be entirely or partially stored on a computer-readable storage medium. The computer-readable storage medium may be packaged together with a processor of a controller, or may be packaged separately from the processor of the controller. This is not limited in the present disclosure.

It can be learned that the solutions provided in the embodiments of the present disclosure are mainly described above from the perspective of a method. To implement the foregoing functions, the embodiments of the present disclosure provide corresponding hardware structures and/or software modules for implementing the functions. A person skilled in the art should be easily aware that, in combination with the modules and algorithm steps of the examples described in the embodiments disclosed in this specification, the embodiments of the present disclosure can be implemented by hardware or a combination of hardware and computer software. Whether a function is performed by hardware or hardware driven by computer software depends on particular applications and design constraints of the technical solutions. A person skilled in the art may use different methods to implement the described functions for each particular application, but such implementation is not to be considered as going beyond the scope of the present disclosure.

It should be understood that the electrical connection mentioned in the present disclosure is not only a circuit connection with physical contact, but also a connection manner in the electrical field such as a wireless connection or a communication connection. A person skilled in the art can make various modifications and variations based on actual conditions without departing from the scope of the present disclosure.

In embodiments of the present disclosure, the controller may be divided into function modules based on the foregoing method examples, for example, each function module may be obtained through division based on each corresponding function, or two or more functions may be integrated into one processing module. The integrated module may be implemented in a form of hardware or may be implemented in a form of a software functional module. In some embodiments of the present disclosure, division into modules is used as an example, and is merely logical function division. In actual implementation, another division manner may be used.

A person skilled in the art should be aware that in the foregoing one or more examples, functions described in the present disclosure may be implemented by hardware, software, firmware, or any combination thereof. When implemented by using software, the functions can be stored in a computer-readable medium or can be used as one or more instructions or code in a computer-readable medium for transmission. The computer-readable medium includes a computer storage medium and a communication medium, where the communication medium includes any medium that enables a computer program to be transmitted from one place to another. The storage medium may be any available medium accessible to a general-purpose or a dedicated computer.

The foregoing descriptions about implementations allow a person skilled in the art to understand that, for the purpose of convenient and brief description, division of the foregoing functional modules is taken as an example for illustration. In actual application, the foregoing functions can be allocated to different modules and implemented according to a requirement, that is, an inner structure of an apparatus is divided into different functional modules to implement all or some of the functions described above.

In the several embodiments provided in the present disclosure, it should be understood that the disclosed apparatus and method may be implemented in other manners. For example, the described apparatus embodiment is merely an example. For example, the module or unit division is merely logical function division and may be other division during actual implementation. For example, a plurality of units or components may be combined or integrated into another apparatus, or some features may be omitted or not performed. In addition, the displayed or discussed mutual couplings or direct couplings or communication connections may be implemented through some interfaces. The indirect couplings or communication connections between the devices or units may be implemented in electronic, mechanical, or other forms. The units described as separate components may or may not be physically separate, and components displayed as units may be one or more physical units, may be located in one place, or may be distributed on a plurality of different places. Some or all of the units may be selected based on actual requirements to achieve the objectives of the solutions of embodiments.

In addition, functional units in the embodiments of the present disclosure may be integrated into one processing unit, or each of the units may exist alone physically, or two or more units are integrated into one unit. The integrated unit may be implemented in a form of hardware, or may be implemented in a form of a software functional unit. When the integrated unit is implemented in the form of a software functional unit and sold or used as an independent product, the integrated unit may be stored in a readable storage medium. Based on such an understanding, the technical solutions in the embodiments of the present disclosure essentially, or the part contributing to the prior art, or all or some of the technical solutions may be implemented in the form of a software product. The software product is stored in a storage medium and includes several instructions for instructing a device (which may be a single-chip microcomputer, a chip, or the like) or a processor (processor) to perform all or some of the steps of the methods described in the embodiments of the present disclosure. The foregoing storage medium includes any medium that can store program code, such as a USB flash drive, a removable hard disk, a ROM, a RAM, a magnetic disk, or an optical disc.

The foregoing descriptions are merely specific implementations of the present disclosure, but are not intended to limit the protection scope of the present disclosure. Any variation or replacement within the technical scope disclosed in the present disclosure shall fall within the protection scope of the present disclosure. Therefore, the protection scope of the present disclosure shall be subject to the protection scope of the claims.

In an implementation, with the progress and development of the times, application fields of electric energy become increasingly extensive, users' demand for electricity is increasing, an increasing quantity of apparatuses require electricity, and an increasing quantity of sites require electricity. For an operation site with high electricity demand, for example, an operation site for fracturing in an oil and gas field, a mobile power generation apparatus is usually needed to supply power to an external power-consuming apparatus such as a fracturing apparatus, to ensure normal working of the external power-consuming apparatus such as the fracturing apparatus.

The mobile power generation apparatus usually supplies power to the external power-consuming apparatus, such as the fracturing apparatus, by combining a gas turbine and a power generator. In a specific process of supplying power, the external power supply apparatus is required to supply power for normal operation of the gas turbine, for example, supply power to a starting mechanism of the gas turbine. However, once a power shortage or power outage occurs at a power consumption site, the mobile power generation apparatus consequently cannot be normally started and further cannot supply power to the external power-consuming apparatus such as the fracturing apparatus.

In conclusion, the mobile power generation apparatus in the related art is prone to a failure in starting normally.

To resolve the foregoing problems, the embodiments of the present disclosure provide a mobile power generation apparatus and a fracturing system.

To make the objectives, technical solutions, and advantages of the present disclosure clearer, the following describes the technical solutions in the embodiments of the present disclosure with reference to the accompanying drawings in the embodiments of the present disclosure. Apparently, the described embodiments are some of the embodiments of the present disclosure rather than all the embodiments. All other embodiments obtained by a person of ordinary skill in the art based on embodiments of the present disclosure without creative efforts shall fall within the protection scope of the present disclosure.

With reference to the accompanying drawings, the mobile power generation apparatus disclosed in the embodiments of the present disclosure is described below in detail through specific embodiments and application scenarios thereof.

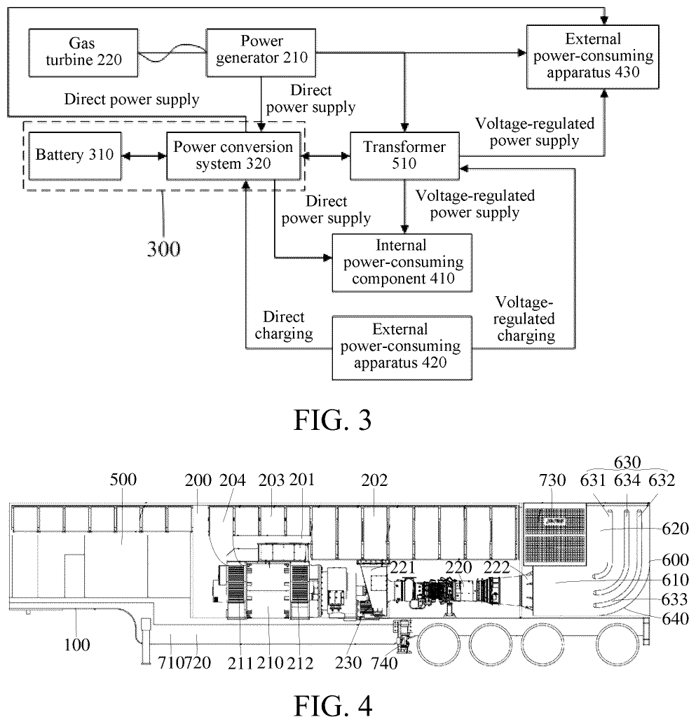

Referring to FIG. 3 and FIG. 6, the present disclosure discloses a mobile power generation apparatus. The disclosed mobile power generation apparatus includes a vehicle 100.

The mobile power generation apparatus disclosed in the present disclosure may be applied to a fracturing site. To be specific, the mobile power generation apparatus can supply power to an external power-consuming apparatus 430 at the fracturing site, to ensure normal working of the external power-consuming apparatus 430.

The vehicle 100 is a main component of the mobile power generation apparatus for implementing movement. An energy storage device 300, a power generator 210, a gas turbine 220, and a starting mechanism 230 for driving the gas turbine 220 to work are arranged on the vehicle 100. To be specific, the starting mechanism 230 is coupled to the gas turbine 220 to drive the gas turbine 220 to work, so that the gas turbine 220 outputs a driving force.

Because the power generator 210 is connected to the gas turbine 220, the driving force output by the gas turbine 220 can drive the power generator 210 to rotate to generate power, so that the mobile power generation apparatus has a power generation function.

The energy storage device 300 may store a specific amount of electricity, and the energy storage device 300 may be electrically connected to the starting mechanism 230 to supply power to the starting mechanism 230. To be specific, in a case that an accidental power outage or power shortage occurs at the fracturing site, the energy storage device 300 can supply power to the starting mechanism 230 in time, to ensure normal working of the gas turbine 220, thereby ensuring normal power generation of the power generator 210, and further ensuring normal working of the mobile power generation apparatus. In some implementations, the starting mechanism 230 may be a component such as a starter. In some implementations, the starting mechanism 230 can not only be configured to start the gas turbine 220, but also be configured to perform turning.

The starting mechanism 230 is one of internal power-consuming components 410 of the mobile power generation apparatus. In some implementations, the energy storage device 300 may also be electrically connected to another internal power-consuming component 410 of the mobile power generation apparatus to supply power to the internal power-consuming component 410, where the internal power-consuming component 410 may be a component, such as a lighting component, a heater for a low-temperature start of the gas turbine 220, a lubricant pump of a lubrication system 710 described below, and a fan described below, on the mobile power generation apparatus, thereby ensuring that the internal power-consuming component 410 can work normally.

In some implementations, the energy storage device 300 may supply alternating-current power of 480 V (or another voltage level such as 110 V) to the starting mechanism 230 and other internal power-consuming components 410, to drive the starting mechanism 230 and the other internal power-consuming components 410 to work normally.

In the present disclosure, because the energy storage device 300 built in the mobile power generation apparatus can supply power to the starting mechanism 230 for driving the gas turbine 220 to work, it is ensured that the gas turbine 220 can work normally. In other words, without an external power supply apparatus 420, the gas turbine 220 can be normally started through the energy storage device 300. In addition, the gas turbine 220 works normally, and can also transmit power to the external power-consuming apparatus 430 through the power generator 210. It can be learned that it avoids that the mobile power generation apparatus cannot be normally started due to a power shortage or power outage at a power consumption site, which, therefore, endows the mobile power generation apparatus with a black start capability. Therefore, the mobile power generation apparatus disclosed in the present disclosure can resolve a problem that the mobile power generation apparatus in the related art is prone to a failure in starting normally.

In some implementations, the energy storage device 300 may include only a battery 310. The battery 310 may directly supply power to the starting mechanism 230. To be specific, the battery 310 may be directly electrically connected to the starting mechanism 230, to supply power to the starting mechanism 230.

In another embodiment, the energy storage device 300 may further include a PCS 320. The PCS 320 can be configured to control charging and discharging processes of the battery 310, so that direct current-alternating current conversion can be performed, thereby improving power quality of power supply. The battery 310 is electrically connected to the PCS 320, and the PCS 320 may be electrically connected to the starting mechanism 230. That is, the battery 310 may supply power to the starting mechanism 230 through the PCS 320.

In some implementations, the PCS 320 may be directly electrically connected to the starting mechanism 230, or when a voltage required by the starting mechanism 230 is high or low, a voltage of the battery 310 may be regulated by a transformer 510. That is, the transformer 510 is further arranged on the vehicle 100, and the PCS 320 may be electrically connected to the starting mechanism 230 by the transformer 510, to enable the battery 310 to supply power to the starting mechanism 230.

In some implementations, a control and power system 500 may be further arranged on the vehicle 100. The control and power system 500 can ensure stable operation of power of the entire mobile power generation apparatus. The control and power system 500 may be arranged in an inner cavity 201 of a compartment 200 described below, or the control and power system 500 and the compartment 200 may be arranged side by side on the vehicle 100. Certainly, a position at which the control and power system 500 is arranged on the vehicle 100 is not specifically limited in this embodiment of the present disclosure.

In some implementations, the energy storage device 300 may be arranged in the control and power system 500, and the transformer 510 may also be arranged in the control and power system 500. That is, the transformer 510 used in the present disclosure may be a transformer built in the control and power system 500, so that the control and power system 500 is fully used. Certainly, positions at which the energy storage device 300 and the transformer 510 are arranged are not specifically limited in this embodiment of the present disclosure.

In an embodiment, the battery 310 may be a replaceable battery. To be specific, after power in the battery 310 is used up, operators may replace the battery 310 with one more fully charged.

In another embodiment, to improve power supply efficiency of the energy storage device 300, that is, to ensure that the energy storage device 300 can continuously and uninterruptedly supply power to the starting mechanism 230, the PCS 320 may be further electrically connected to an external power supply apparatus 420. The external power supply apparatus 420 may be an external power supply at a fracturing site. If a voltage provided by the external power supply apparatus 420 satisfies a power supply requirement of the energy storage device 300, the external power supply apparatus 420 directly supplies electric energy to the PCS 320, and the PCS 320 charges the battery 310 after performing conversion. Alternatively, if a voltage provided by the external power supply apparatus 420 cannot satisfy a requirement of direct charging of the energy storage device 300, that is, if a voltage transmitted by the external power supply apparatus 420 is higher or lower, the voltage may be regulated by the transformer 510 to a voltage required by the battery 310, to charge the battery 310. It can be learned that, such a manner of charging the battery 310 by the external power supply apparatus 420 can improve efficiency of supplying power by the energy storage device 300 to the starting mechanism 230. That is, the energy storage device 300 is continuously charged by using the external power supply apparatus 420, so that the energy storage device 300 can continuously supply power to the starting mechanism 230, thereby improving the power supply efficiency.

Additionally or Alternatively, in an embodiment, the battery 310 can be charged by only the external power supply apparatus 420. In another embodiment, to improve charging efficiency of the battery 310, the PCS 320 may also be electrically connected to the power generator 210. To be specific, electric energy provided by the power generator 210 can continuously charge the battery 310 through the PCS 320, so that the energy storage device 300 can continuously supply power to the starting mechanism 230. It can be learned that, provided that the power generator 210 is working, the power generator 210 can continuously charge the battery 310, so that the battery 310 can always store a specific amount of electric energy.

When both the external power supply apparatus 420 and the power generator 210 charge the battery 310, that is, the external power supply apparatus 420 and the power generator 210 charge the battery 310 simultaneously, charging efficiency of the battery 310 may be improved, and when one of the external power supply apparatus 420 and the power generator 210 cannot charge the battery 310, the other thereof charges the battery 310 without being affected. That is, the energy storage device 300 can always supply power to the starting mechanism 230.

In some implementations, the PCS 320 may be directly electrically connected to the power generator 210, or when a voltage transmitted by the power generator 210 is higher or lower, the voltage may be regulated by the transformer 510 to a voltage required by the battery 310, to charge the battery 310. That is, the PCS 320 may also be electrically connected to the power generator 210 by the transformer 510, to enable the power generator 210 to charge the battery 310.

In some implementations, the external power supply apparatus 420 and the power generator 210 may also directly supply power to the internal power-consuming component 410, or when voltages provided by the external power supply apparatus 420 and the power generator 210 cannot meet a requirement of directly supplying power to the internal power-consuming component 410, the voltages are regulated by the transformer 510 to a voltage required by the internal power-consuming component 410, to supply power to the internal power-consuming component 410.

In an embodiment, the energy storage device 300 can supply power to only the starting mechanism 230. In another embodiment, to fully use the energy storage device 300, the energy storage device 300 may further be electrically connected to the external power-consuming apparatus 430, to supply power to the external power-consuming apparatus 430. Specifically, as described above, the PCS 320 of the energy storage device 300 is electrically connected to the external power-consuming apparatus 430, to supply power to the external power-consuming apparatus 430.

In some implementations, the energy storage device 300 may be directly electrically connected to the external power-consuming apparatus 430, or when a voltage required by the external power-consuming apparatus 430 is higher or lower, a voltage may be regulated by a transformer 510 to the voltage required by the external power-consuming apparatus 430, to supply power to the external power-consuming apparatus 430. That is, the transformer 510 is further arranged on the vehicle 100. In this case, the energy storage device 300 may be electrically connected to the external power-consuming apparatus 430 by the transformer 510. Specifically, the PCS 320 of the energy storage device 300 may be electrically connected to the external power-consuming apparatus 430 by the transformer 510, to supply power to the external power-consuming apparatus 430. In this embodiment, the transformer 510 and the transformer 510 described above may be a same transformer. Certainly, this is not specifically limited in this embodiment of the present disclosure.

In an embodiment, the power generator 210, the gas turbine 220, and the starting mechanism 230 may all be exposed to an external environment.

In another embodiment, to prevent the power generator 210, the gas turbine 220, and the starting mechanism 230 from being adversely affected, a compartment 200 is further arranged on the vehicle 100. The power generator 210, the gas turbine 220, and the starting mechanism 230 may all be arranged in an inner cavity 201 of the compartment 200. To be specific, the power generator 210, the gas turbine 220, and the starting mechanism 230 are arranged in the inner cavity 201, so that the compartment 200 can protect all of the power generator 210, the gas turbine 220, and the starting mechanism 230. In some implementations, the compartment 200 may be a silencing compartment. Because the power generator 210, the gas turbine 220, and the starting mechanism 230 may generate some noise during working, a noise reduction function may be implemented by the silencing compartment.

In an embodiment, only a first air inlet 202 and a second air inlet 203 may be provided spaced apart on the compartment 200. The first air inlet 202 is in communication with a gas inlet 221 of the gas turbine 220. That is, the first air inlet 202 provides combustion air for the gas turbine 220. The second air inlet 203 is in communication with the inner cavity 201. That is, cooling air may be fed through the second air inlet 203 into the inner cavity 201, to cool the gas turbine 220, the power generator 210, and other components in the inner cavity 201. In other words, a cooling air inlet 211 of the power generator 210 may be in communication with the inner cavity 201. In this case, because both the gas turbine 220 and the power generator 210 need to be cooled by the cooling air in the inner cavity 201, a fan with a large power needs to be configured in the inner cavity 201 to draw air, to increase a ventilation volume of the inner cavity 201.

In another embodiment, a third air inlet 204 may be further provided on the compartment 200. The first air inlet 202, the second air inlet 203, and the third air inlet 204 are provided at intervals, and the third air inlet 204 is in communication with the cooling air inlet 211 of the power generator 210. In some implementations, the third air inlet 204 may be in communication with the cooling air inlet 211 through a vent pipe, so that air passing through the third air inlet 204 may enter the cooling air inlet 211. It can be learned that the power generator 210 is cooled alone through the third air inlet 204, so that the power generator 210 does not need to be cooled by the cooling air in the inner cavity 201, which lowers a requirement for the ventilation volume of the inner cavity 201, so that it is not needed to configure a fan with a large power in the inner cavity 201, that is, a requirement of the inner cavity 201 for fan selection is lowered.

In some implementations, the first air inlet 202, the second air inlet 203, and the third air inlet 204 may all be provided on a side plate of the compartment 200, or referring to FIG. 4, the first air inlet 202, the second air inlet 203, and the third air inlet 204 may all be provided on a top plate of the compartment 200. Certainly, this is not specifically limited in this embodiment of the present disclosure.

In some implementations, to further improve cooling efficiency for the power generator 210, a fan may also be configured in the power generator 210, to increase an air inlet volume of the cooling air inlet 211 through the fan, thereby improving cooling efficiency of the power generator 210.

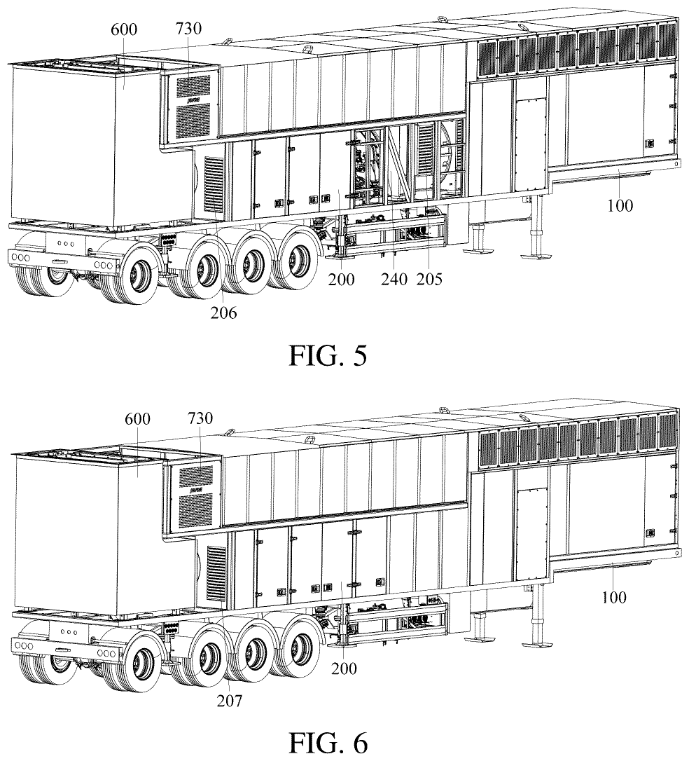

In an embodiment, referring to FIG. 5, a first air outlet 205 and a second air outlet 206 are further provided spaced apart on the compartment 200. A cooling air outlet 212 of the power generator 210 is in communication with the external environment through the first air outlet 205. That is, after cooling air entering the power generator 210 through the cooling air inlet 211 takes away heat of the power generator 210, the cooling air may be discharged from the cooling air outlet 212, and then all the cooling air with heat may be discharged to the external environment through the first air outlet 205. In some implementations, the cooling air outlet 212 may be in communication with the first air outlet 205 through the connecting channel 240. Certainly, the cooling air outlet 212 may alternatively be in direct communication with the first air outlet 205. This is not specifically limited in this embodiment of the present disclosure. The second air outlet 206 communicates the inner cavity 201 with the external environment. To be specific, cooling air entering the inner cavity 201 through the second air inlet 203 may be discharged from the second air outlet 206 to the external environment after taking away heat from outer surfaces of the power generator 210, the gas turbine 220, and other components, and the second air outlet 206 may be arranged away from the gas turbine 220.

In another embodiment, the second air outlet 206 is arranged close to the gas turbine 220. In this case, when cooling air entering the inner cavity 201 through the second air inlet 203 flows to the second air outlet 206, most of the cooling air passes through the gas turbine 220, to cool the gas turbine 220, thereby ensuring normal working of the gas turbine 220.

In some implementations, the first air outlet 205 and the second air outlet 206 may be provided on a top plate of the compartment 200, or referring to FIG. 5, the first air outlet 205 and the second air outlet 206 may be provided on a side plate of the compartment 200. Certainly, this is not specifically limited in this embodiment of the present disclosure. In some implementations, the first air outlet 205 and the second air outlet 206 may be provided on a same side plate or top plate of the compartment 200 as the first air inlet 202, the second air inlet 203, and the third air inlet 204. Certainly, this is not specifically limited in this embodiment of the present disclosure.

In other embodiments, referring to FIG. 6, a third air outlet 207 is further provided on the compartment 200. The cooling air outlet 212 of the power generator 210 is in communication with the inner cavity 201, and the inner cavity 201 is in communication with the external environment through the third air outlet 207. To be specific, after being discharged through the cooling air outlet 212, cooling air for cooling the power generator 210 enters the inner cavity 201. In a process of flowing to the third air outlet 207, this part of cooling air may be combined with the cooling air entering the inner cavity 201 through the second air inlet 203, to jointly cool the gas turbine 220 and other components in the inner cavity 201, for example, the starting mechanism 230, to improve cooling efficiency of the gas turbine 220 and the starting mechanism 230, thereby further ensuring normal working of the gas turbine 220 and the starting mechanism 230. Finally, the cooling air for cooling the power generator 210 and the cooling air for cooling the gas turbine 220 are both discharged to the external environment through the third air outlet 207.

In some implementations, the third air outlet 207 may be provided close to the gas turbine 220, and may be specifically provided close to a gas outlet 222 of the gas turbine 220. In this case, the third air outlet 207 may be provided on a side plate of the compartment 200, so that more cooling air can pass through the gas turbine 220 and cool the gas turbine 220.

In some implementations, the third air outlet 207 may be provided on a same side plate or top plate of the compartment 200 as the first air inlet 202, the second air inlet 203, and the third air inlet 204. Certainly, this is not specifically limited in this embodiment of the present disclosure.

In some implementations, to increase an exhaust rate of the inner cavity 201, there may be at least two third air outlets 207, and different third air outlets 207 may be provided on different side plates of the compartment 200. Certainly, this is not specifically limited in this embodiment of the present disclosure.

In some implementations, an exhaust system 600 is further arranged on the vehicle 100. The gas outlet 222 of the gas turbine 220 is in communication with the exhaust system 600. That is, exhaust gas generated after working of the gas turbine 220 may be discharged to the external environment through the gas outlet 222 and the exhaust system 600, and the power generator 210, the gas turbine 220, and the exhaust system 600 may be sequentially arranged.

In an embodiment, the power generator 210, the gas turbine 220, and the exhaust system 600 may be sequentially arranged in a traveling direction of the vehicle, that is, the exhaust system 600 is arranged close to a front end of the vehicle 100.

In another embodiment, in a direction opposite to a traveling direction of the vehicle 100, the power generator 210, the gas turbine 220, and the exhaust system 600 are sequentially arranged, that is, the exhaust system 600 is arranged close to a tail end of the vehicle 100. As a result, a front part of the vehicle 100 weighs more. In addition, because the exhaust system 600 is placed at the tail end of the vehicle 100, there is no height restriction on a gooseneck of the vehicle 100, which can lower a height of an entire shaft system, thereby reducing a center of gravity of the entire vehicle 100, and further improving traveling stability of the vehicle 100.

In some implementations, in the direction opposite to the traveling direction of the vehicle 100, the energy storage device 300, the power generator 210, the gas turbine 220, and the exhaust system 600 may be sequentially arranged. Certainly, a position at which the energy storage device 300 is arranged relative to the power generator 210, the gas turbine 220, and the exhaust system 600 is not specifically limited in this embodiment of the present disclosure.

In an embodiment, the exhaust system 600 may include only the first exhaust pipe 610, the gas outlet 222 is in communication with the first exhaust pipe 610, and the first exhaust pipe 610 may extend in the traveling direction of the vehicle 100.

In another embodiment, the exhaust system may further include a second exhaust pipe 620 in communication with the first exhaust pipe 610. The first exhaust pipe 610 and the second exhaust pipe 620 are perpendicular to each other. That is, an extending direction of the first exhaust pipe 610 is perpendicular to an extending direction of the second exhaust pipe 620. In addition, the first exhaust pipe 610 is in communication with the second exhaust pipe 620. The second exhaust pipe 620 may increase a discharge height of exhaust gas to some extent, to avoid affecting normal working of surrounding operators.

In an embodiment, the exhaust system 600 may include only the first exhaust pipe 610 and the second exhaust pipe 620.

In another embodiment, the exhaust system 600 may further include a silencer 630. The silencer 630 has a noise reduction effect. Therefore, the silencer 630 may be arranged in at least one of the first exhaust pipe 610 and the second exhaust pipe 620, to reduce noise generated when the exhaust system 600 discharge exhaust gas.

In an embodiment, there may be one silencer 630. In another embodiment, there may be at least two silencers 630. That is, a plurality of silencers 630 may further improve noise reduction efficiency.

In an embodiment, at least two silencers 630 in a plurality of silencers 630 are sequentially and evenly arranged in the first exhaust pipe 610 and/or the second exhaust pipe 620. In another embodiment, at least two silencers 630 in the plurality of silencers 630 are unevenly arranged in the first exhaust pipe 610 and/or the second exhaust pipe 620. Specifically, the at least two silencers 630 in the plurality of silencers 630 are sequentially arranged. To be specific, the at least two silencers 630 are sequentially arranged in the first exhaust pipe 610 in a height direction of the mobile power generation apparatus, and/or the at least two silencers 630 are sequentially arranged in the second exhaust pipe 620 in a traveling direction of the mobile power generation apparatus. In addition, the at least two silencers 630 include a first silencer 631 and a second silencer 632.

In an arrangement direction of the first silencer 631 and the second silencer 632, that is, in a same direction, there is a first distance between the first silencer 631 and the second silencer 632. The exhaust system 600 includes a first inner wall close to the first silencer 631, and the first inner wall is arranged away from the second silencer 632. In other words, in the first silencer 631 and the second silencer 632, the first silencer 631 is closer to the first inner wall, and there is a second distance between the first inner wall and the first silencer 631. In some implementations, the first inner wall may be a first inner wall of the first exhaust pipe 610 or a first inner wall of the second exhaust pipe 620.

The exhaust system 600 further includes a second inner wall close to the second silencer 632, and the second inner wall is arranged away from the first silencer 631. That is, in the first silencer 631 and the second silencer 632, the second silencer 632 is closer to the second inner wall, and there is a third distance between the second inner wall and the second silencer 632. In some implementations, the second inner wall may be a second inner wall of the first exhaust pipe 610 or a second inner wall of the second exhaust pipe 620.

At least two of the first distance, the second distance, and the third distance are different. In this arrangement manner, at least two silencers 630 in the plurality of silencers 630 can be unevenly arranged in the exhaust system 600, so that an airflow rate of exhaust gas is effectively adjusted, thereby improving noise reduction and resistance reduction effects to some extent.

In a further embodiment, the first distance, the second distance, and the third distance are all different. That is, in this arrangement manner, a larger quantity of silencers 630 can be unevenly arranged in the exhaust system 600, so that an airflow rate of exhaust gas is more effectively adjusted, thereby improving noise reduction and resistance reduction effects.

In some implementations, the first inner wall is arranged opposite to the second inner wall. That is, the first inner wall of the first exhaust pipe 610 is arranged opposite to the second inner wall of the first exhaust pipe 610, the first inner wall of the second exhaust pipe 620 is arranged opposite to the second inner wall of the second exhaust pipe 620, and the first inner wall of the first exhaust pipe 610, the second inner wall of the first exhaust pipe 610, the first inner wall of the second exhaust pipe 620, and the second inner wall of the second exhaust pipe 620 may constitute partial inner walls of the exhaust system 600.

In some implementations, there may be at least three silencers 630. At least three silencers 630 in a plurality of silencers 630 are sequentially arranged. Specifically, the at least three silencers 630 in the plurality of silencers 630 are sequentially arranged in the first exhaust pipe 610 in a height direction of the mobile power generation apparatus, and/or the at least three silencers 630 in the plurality of silencers 630 are sequentially arranged in the second exhaust pipe 620 in a traveling direction of the mobile power generation apparatus. In addition, distances between at least two groups of adjacent silencers 630 in the at least three silencers 630 are different. Specifically, referring to FIG. 4, the at least three silencers 630 include the first silencer 631 and the second silencer 632 described above, and further include a third silencer 634. The first silencer 631, the third silencer 634, and the second silencer 632 are sequentially arranged. In other words, the third silencer 634 is located between the first silencer 631 and the second silencer 632. In an arrangement direction of the first silencer 631, the third silencer 634, and the second silencer 632, a distance between the first silencer 631 and the third silencer 634 is different from a distance between the third silencer 634 and the second silencer 632. In this arrangement manner, the at least three silencers 630 in the plurality of silencers 630 can be unevenly arranged, so that an airflow rate of the exhaust gas is effectively adjusted, thereby improving noise reduction and resistance reduction effects.

In an embodiment, in an arrangement direction of the at least three silencers 630, that is, in a same direction, there is the second distance between the first silencer 631 and the first inner wall of the exhaust system 600, and there is the third distance between the second silencer 632 and the first inner wall of the exhaust system 600. The second distance and the third distance may be equal.

In another embodiment, to further effectively adjust the airflow rate of the exhaust gas, the first distance and the second distance are not equal. To be specific, while the distance between the first silencer 631 and the third silencer 634 is not equal to the distance between the third silencer 634 and the second silencer 632, the first distance and the second distance are also different, so that the plurality of silencers 630 can be unevenly arranged in the exhaust system 600, thereby further improving noise reduction and reducing resistance effects.

In an embodiment, no other structure is arranged at an end of the silencer 630 close to the gas outlet 222, for example, a guide portion 633 described below.

In another embodiment, referring to FIG. 4, a guide portion 633 is arranged at an end of the silencer 630 close to the gas outlet 222. The guide portion 633 is arc-shaped, and the arc-shaped guide portion 633 can better guide an airflow, thereby improving exhaust gas emission efficiency, and further reducing exhaust resistance of the gas turbine 220.

Specifically, an extending direction of the first exhaust pipe 610 may be the same as a traveling direction of the mobile power generation apparatus. That is, the extending direction of the first exhaust pipe 610 is a horizontal direction. An extending direction of the second exhaust pipe 620 may be the same as a height direction of the mobile power generation apparatus. That is, the extending direction of the second exhaust pipe 620 is a vertical direction. The exhaust system 600 may further include an arc-shaped curved pipe 640. The first exhaust pipe 610 and the second exhaust pipe 620 are in communication through the arc-shaped curved pipe 640. That is, the arc-shaped curved pipe 640 is used as a transition between the first exhaust pipe 610 and the second exhaust pipe 620. The guide portion 633 is located at the arc-shaped curved pipe 640, and an extending direction of the guide portion 633 is the same as an extending direction of the arc-shaped curved pipe 640, so that the guide portion 633 can guide an airflow.

Additionally/alternatively, in a case that the first exhaust pipe 610 and the second exhaust pipe 620 are in direct communication, the first exhaust pipe 610 and the second exhaust pipe 620 have a junction, the arc-shaped guide portion 633 is arranged at the junction, and the junction is a position at which gas flows from the first exhaust pipe 610 to the second exhaust pipe 620. In this case, an extending direction of the guide portion 633 is the same as a flowing direction of gas in the exhaust system 600 at the junction. To be specific, the extending direction of the guide portion 633 matches a flowing direction change of the gas when flowing from the horizontal direction to the vertical direction, and a flowing direction of the gas at the junction between the first exhaust pipe 610 and the second exhaust pipe 620 is substantially tangent to both the horizontal direction and the vertical direction. In some implementations, a central angle of the arc-shaped guide portion 633 is substantially 90°, so that the guide portion 633 can better guide an airflow at the junction between the first exhaust pipe 610 and the second exhaust pipe 620.

In some implementations, the mobile power generation apparatus disclosed in the present disclosure may further include a lubrication system 710 and a fuel system 720. The lubrication system 710 and the fuel system 720 are arranged on two sides of the vehicle 100 or at positions in the middle of a girder of the vehicle 700. The lubrication system 710 is configured to provide lubricant for the power generator 210 and the gas turbine 220, and the fuel system 720 is configured to provide fuel for the gas turbine 220, thereby ensuring normal and stable working of the power generator 210 and the gas turbine 220. Because the energy storage device 300 can supply power to a lubricant pump of the lubrication system 710, when the power generator 210 and the gas turbine 220 are abnormally shutdown, there is no need for an additional direct-current lubrication system or an external power supply apparatus to ensure normal operation of the lubrication system 710 during shutdown of the power generator 210 and the gas turbine 220.

In some implementations, the mobile power generation apparatus disclosed in the present disclosure may further include a radiator 730. The radiator 730 is configured to cool lubricant in the lubrication system 710. That is, the radiator 730 is a cooling system for the lubrication system 710. The radiator 730 may be arranged on the compartment 200. The radiator 730 ensures normal and stable working of the lubricant pump, the power generator 210, and the gas turbine 220 by cooling the lubricant.

In some implementations, because the ground of a fracturing site or a power-consuming site is generally not level, the vehicle 100 may be in an inclined state, and further, the compartment 200 may be in an inclined state. In this case, the mobile power generation apparatus may further include a support mechanism 740. The support mechanism 740 is arranged on a side surface of the vehicle 100, to adjust levelness of the entire vehicle 100, and further adjust levelness of the power generator 210 and the gas turbine 220, to ensure normal, stable, and safe working of the power generator 210 and the gas turbine 220.

In some implementations, the present disclosure further discloses a fracturing system, including a load module and a power supply module. The power supply module is electrically connected to the load module to supply power to the load module, thereby ensuring that normal working of the load module.

In some implementations, the load module may be the external power-consuming apparatus 430 described above, and the power supply module may be a generator set and/or the mobile power generation apparatus described above. The generator set has a power generation function.

In some implementations, the load module may include a gas fracturing apparatus and an electric fracturing apparatus. The gas fracturing apparatus and the electric fracturing apparatus may coordinate to complete a hydraulic fracturing construction operation at a fracturing site, and the gas fracturing apparatus and the electric fracturing apparatus may serve as a standby apparatus for each other, to improve stability of fracturing operation at a well site, thereby lowering a risk caused by an operating apparatus failure at the site.

The generator set is electrically connected to the gas fracturing apparatus and/or the electric fracturing apparatus to supply power to the gas fracturing apparatus and/or the electric fracturing apparatus. Specifically, the generator set may include a gas turbine and a power generator connected to each other. Because the power generator is connected to the gas turbine, a driving force output by the gas turbine during working can drive the power generator to rotate to generate power, so that the generator set has a power generation function. In addition, the generator set is electrically connected to the gas fracturing apparatus and/or the electric fracturing apparatus by the power generator, so that the power generator supplies power to the gas fracturing apparatus and/or the electric fracturing apparatus.

In some implementations, a structure and functions of the gas turbine may be consistent with the structure and functions of the gas turbine 220 described above, and a structure and functions of the power generator may be consistent with the structure and functions of the power generator 210 described above. Certainly, this is not specifically limited in this embodiment of the present disclosure provided that the power generator set implements the power generation function through the gas turbine and the power generator.

In some implementations, the power generator of the power generator set may be directly electrically connected to the gas fracturing apparatus and/or the electric fracturing apparatus to supply power to the gas fracturing apparatus and/or the electric fracturing apparatus. However, when a voltage transmitted by the power generator is higher or lower, the voltage may be regulated by a transformer in the power generator set to a voltage required by the gas fracturing apparatus and/or the electric fracturing apparatus to supply power to the gas fracturing apparatus and/or the electric fracturing apparatus. Specifically, the power generator may output alternating-current power of 480 V (or another voltage level such as 110 V) externally through the transformer.

Additionally/alternatively, because the mobile power generation apparatus described above includes the power generator 210 and the energy storage device 300, the power generator 210 may be electrically connected to the gas fracturing apparatus and/or the electric fracturing apparatus to supply power to the gas fracturing apparatus and/or the electric fracturing apparatus, that is, the gas fracturing apparatus and the electric fracturing apparatus may both obtain power supplied by the power generator 210, thereby ensuring normal working of the gas fracturing apparatus and the electric fracturing apparatus.

Additionally/alternatively, the energy storage device 300 may be electrically connected to the gas fracturing apparatus and/or the electric fracturing apparatus to supply power to the gas fracturing apparatus and/or the electric fracturing apparatus, that is, at least one of the gas fracturing apparatus and the electric fracturing apparatus may obtain power supplied by the energy storage device 300, thereby ensuring normal working of the at least one of the gas fracturing apparatus and the electric fracturing apparatus.

In a case that the power generator 210 and the energy storage device 300 supply power to the gas fracturing apparatus and/or the electric fracturing apparatus, when one of the power generator 210 and the energy storage device 300 cannot supply power to the gas fracturing apparatus and/or the electric fracturing apparatus, the other thereof supplies power to the gas fracturing apparatus and/or the electric fracturing apparatus without being affected, that is, it is ensured that the gas fracturing apparatus and/or the electric fracturing apparatus can always work normally.

In a case that the generator set and the mobile power generation apparatus jointly supply power to the gas fracturing apparatus and/or the electric fracturing apparatus, when one of the generator set and the mobile power generation apparatus cannot supply power to the gas fracturing apparatus and/or the electric fracturing apparatus, the other thereof supplies power to the gas fracturing apparatus and/or the electric fracturing apparatus without being affected, that is, it is ensured that the gas fracturing apparatus and/or the electric fracturing apparatus can always work normally.

In some implementations, the energy storage device 300 may include only a battery 310. The battery 310 may be directly electrically connected to the gas fracturing apparatus and/or the electric fracturing apparatus to supply power to the gas fracturing apparatus and/or the electric fracturing apparatus.

In another embodiment, the energy storage device 300 may further include a PCS 320. The PCS 320 can be configured to control charging and discharging processes of the battery 310, so that direct current-alternating current conversion can be performed, thereby improving electric energy quality of power supply. The battery 310 is electrically connected to the PCS 320, and the PCS 320 may be electrically connected to the gas fracturing apparatus and/or the electric fracturing apparatus. That is, the battery 310 may supply power to the gas fracturing apparatus and/or the electric fracturing apparatus through the PCS 320.

In this embodiment, the PCS 320 may be directly electrically connected to the gas fracturing apparatus and/or the electric fracturing apparatus, that is, the battery 310 may directly supply power to the gas fracturing apparatus and/or the electric fracturing apparatus through the PCS 320. However, when a voltage required by the gas fracturing apparatus and/or the electric fracturing apparatus is relatively higher or lower, after power in the battery 310 is converted by the PCS 320, and then has a voltage regulated by the transformer 510 of the mobile power generation apparatus, the power is supplied to the gas fracturing apparatus and/or the electric fracturing apparatus. In some implementations, the transformer 510 may be the transformer 510 described above.

Similarly, the power generator 210 may be directly electrically connected to the gas fracturing apparatus and/or the electric fracturing apparatus to supply power to the gas fracturing apparatus and/or the electric fracturing apparatus. However, when a voltage transmitted by the power generator 210 is higher or lower, the voltage may be regulated by the transformer 510 to a voltage required by the gas fracturing apparatus and/or the electric fracturing apparatus to supply power to the gas fracturing apparatus and/or the electric fracturing apparatus. Specifically, the power generator 210 may output alternating-current power of 480 V (or another voltage level such as 110 V) externally through the transformer 510.

When the energy storage device 300 and the power generator 210 jointly supply power to the gas fracturing apparatus and/or the electric fracturing apparatus, that is, when the mobile power generation apparatus supplies power to the gas fracturing apparatus and/or the electric fracturing apparatus, after a voltage provided by the energy storage device 300 and a voltage provided by the power generator 210 are regulated by the transformer 510 to be consistent, the energy storage device 300 and the power generator 210 are connected in parallel through synchronization to supply power to the gas fracturing apparatus and/or the electric fracturing apparatus.

In some implementations, when the power generator 210 supplies power to the gas fracturing apparatus, 480 V power output by the power generator 210 may be directly supplied to the gas fracturing apparatus, to supply power to a starting motor and a matching power-consuming component of the gas fracturing apparatus. The power-consuming component may be an auxiliary power-consuming system of the gas fracturing apparatus, for example, a component, such as a lubrication system, a heater, and a radiator, on the gas fracturing apparatus, thereby ensuring that the gas fracturing apparatus can be started to run. In some implementations, the 480 V power may alternatively be directly supplied to necessary apparatuses and units on site, such as an instrumentation apparatus and a gas treatment apparatus described below. In some implementations, the power provided by the generator set and the energy storage device 300 is also used to supply power to the starting motor and the matching power-consuming components of the gas fracturing apparatus.

In some implementations, when the power generator 210 supplies power to the electric fracturing apparatus, power generated by the power generator 210 is supplied to a converter apparatus of the fracturing system, the power is converted by the converter apparatus and then supplied to the electric fracturing apparatus, to provide the electric fracturing apparatus with electric energy necessary for working. That is, the electric fracturing apparatus can effectively use a remaining power supply capacity of the power generator 210, to greatly improve operation efficiency and improve operation economy. Specifically, the power generator 210 may supply power of 13.8 kV (or another voltage level) externally. The power of 13.8 kV is supplied to the foregoing converter apparatus. The converter apparatus converts the power into 3.3 kV (or a power specification required by another load motor), and then supplies the power to a main power motor of the electric fracturing apparatus, to finally drive a plunger pump to operate.

Further, if a capacity of the transformer 510 is insufficient, that is, when the power of 480 V output by the power generator 210 externally cannot meet a requirement of the fracturing site for the power specification, a power transformation and distribution apparatus may be added. The power of 13.8 kV output by the power generator 210 is supplied to the power transformation and distribution apparatus, 13.8 kV is converted to 480 V by a high-capacity transformer configured in the power transformation and distribution apparatus, and then, the power is supplied to an apparatus such as the gas fracturing apparatus and/or the electric fracturing apparatus. In addition to being equipped with a transformer with a large capacity, the power transformation and distribution apparatus is usually further equipped with at least one switchgear for emergency cut-off or protection of power (when the apparatus works abnormally, or when electric shock, electric leakage, or the like occurs).

In some implementations, a main fuel of the gas fracturing apparatus, the gas turbine of the generator set, and the gas turbine 220 of the mobile power generation apparatus is natural gas. The natural gas may be natural gas obtained at a fracturing site. Specifically, a source of the natural gas may be one or more of wellhead gas at a well site, compressed natural gas (CNG), or liquefied natural gas (LNG). The fracturing system may further include a natural gas source and a natural gas treatment apparatus. After having moisture, particulate matter, and the like in natural gas treated through the natural gas treatment apparatus, the natural gas source supplies the natural gas to the gas fracturing apparatus and the gas turbine 220.

In some implementations, the fracturing system may further include an electric sand mixing apparatus and an electric blending apparatus. The generator set and the mobile power generation apparatus may jointly supply necessary power to the electric sand mixing apparatus, the electric blending apparatus, and the natural gas treatment apparatus, thereby achieving the entire hydraulic fracturing process requiring only natural gas as a fuel supply.

In addition, in the present disclosure, the generator set and/or the mobile power generation apparatus participates in hydraulic fracturing operation at a well site, to well resolve an external power supply problem that cannot be resolved by simply using a gas fracturing apparatus, which improves the status quo that two types of fuel, natural gas and diesel, needs to be provided during fracturing operation. To be specific, in the present disclosure, only natural gas is used at a fracturing site to drive the gas turbine of the generator set and the gas turbine 220 of the mobile power generation apparatus to work, to further drive the power generator of the generator set to generate power, drive the power generator 210 of the mobile power generation apparatus to generate power, and drive the gas fracturing apparatus to perform fracturing work. In addition, power supply quality of the generator set and/or the mobile power generation apparatus used in the present disclosure is better than that of a conventional diesel-powered generator set or a reciprocating gas-powered generator set.

The foregoing embodiments of the present disclosure focus on describing differences between the embodiments. Different optimization features between the embodiments all can be combined to form a better embodiment provided that there is no contradiction there between. In consideration of the concise description, details are not described herein again.

The foregoing descriptions are merely embodiments of the present disclosure and are not intended to limit the present disclosure. For a person skilled in the art, various modifications and variations can be made to the present disclosure. Any modification, equivalent replacement, or improvement made without departing from the spirit and principle of the present disclosure shall fall within the scope of the claims of the present disclosure.

What is claimed is:

1. A black-start achievable energy storage system, comprising:
an energy storage apparatus; and
a power conversion system, wherein the power conversion system is electrically connected to the energy storage apparatus, and is configured to control, based on a plurality of different operating conditions, the energy storage apparatus to charge and discharge.

2. The black-start achievable energy storage system according to claim 1, further comprising:
a transformer configured to regulate a voltage difference between the black-start achievable energy storage system and an external apparatus.

3. A black-start achievable energy storage method performed by an energy storage system, comprising:
providing a power conversion system connected to an energy storage apparatus; and
configure the power conversion system to perform at least a first control procedure, a second control procedure, a third control procedure, a fourth control procedure, and a fifth control procedure for charging and discharging the energy storage apparatus according to a plurality of different operating configurations.

4. The black-start achievable energy storage method according to claim 3, wherein the first control procedure comprises:
supplying, by an output of the energy storage apparatus, power to an internal power-consuming apparatus through the power conversion system, or by a transformer, when the internal power-consuming apparatus needs a higher voltage or a lower voltage, power to the internal power-consuming apparatus after regulating the out output of the energy storage apparatus.

5. The black-start achievable energy storage method according to claim 3, wherein the second control procedure comprises:
supplying, by an output of the energy storage apparatus, power to an external apparatus through the power conversion system, or by a transformer, when the external apparatus needs a higher voltage or a lower voltage, power to the external apparatus after regulating the output of the energy storage apparatus.

6. The black-start achievable energy storage method according to claim 3, wherein the third control procedure comprises:
connecting the energy storage system and a transformer in parallel through synchronization to supply power to an external apparatus, when both the energy storage system and a generator set are configured to supply power to an external apparatus, and when a voltage generated by the energy storage apparatus, after converted by the power conversion system and then regulated by the transformer, is consistent with a voltage generated by the generator set.

7. The black-start achievable energy storage method according to claim 3, wherein the fourth control procedure comprises:
regulating, by a transformer, a power generated by a generator set, and charging, by the power conversion system, the energy storage apparatus with the regulated power.

8. The black-start achievable energy storage method according to claim 3, wherein the fifth control procedure comprises:
charging, the energy storage system directly by an external power supply through the power conversion system or directly supplying, by the external power supply, power to an internal apparatus, when the external power supply satisfies a requirement of the energy storage system or the internal apparatus; and
supplying power after regulation by a transformer to the energy storage system or the internal apparatus, when the external power supply does not satisfy the requirement of the energy storage system or the internal apparatus.

9. The black-start achievable energy storage system according to claim 1, wherein:
the black-start achievable energy storage system comprises a gas turbine generator set; and
the gas turbine generator set further comprising: a control and power system, a gas turbine, a power generator, a silencing compartment and air inlet system, and an exhaust system.

10. A mobile power generation apparatus, comprising a vehicle equipped with an energy storage device, a power generator, a gas turbine, and a starting mechanism for driving the gas turbine to operate, the power generator being connected to the gas turbine, the energy storage device being electrically connected to the starting mechanism for supplying power to the starting mechanism.

11. The mobile power generation apparatus according to claim 10, wherein the energy storage device further comprises a battery and a power conversion system, wherein:
the battery is electrically connected to the power conversion system and the power conversion system is electrically connected to the starting mechanism; or
a transformer is further arranged on the vehicle and the power conversion system is electrically connected to the starting mechanism via the transformer.

12. The mobile power generation apparatus according to claim 11, wherein:
the power conversion system is further electrically connected to an external power supply apparatus directly or to the external power supply apparatus via the transformer for charging the battery; or
the power conversion system is further electrically connected to the power generator directly or to the power generator via the transformer for charging the battery.

13. The mobile power generation apparatus according to claim 10, wherein:
the energy storage device is electrically connected to an external power-consuming apparatus directly; or
the energy storage device is electrically connected to the external power-consuming apparatus via a transformer to supply power to the external power-consuming apparatus, the transformer being further arranged on the vehicle.

14. The mobile power generation apparatus according to claim 10, wherein:
a compartment is further arranged on the vehicle;
the power generator, the gas turbine, and the starting mechanism are arranged in an inner cavity of the compartment;
a first air inlet, a second air inlet, and a third air inlet are provided on the compartment at intervals, the first air inlet being in communication with a gas inlet of the gas turbine, the second air inlet being in communication with the inner cavity, and the third air inlet being in communication with a cooling air inlet of the power generator.

15. The mobile power generation apparatus according to claim 14, wherein:
a first air outlet and a second air outlet are further provided spaced apart on the compartment;
a cooling air outlet of the power generator in communication with an external environment through the first air outlet is further provided; and
the second air outlet communicates the inner cavity with the external environment, the second air outlet being close to the gas turbine.

16. The mobile power generation apparatus according to claim 14, wherein:
a third air outlet is further provided on the compartment;
a cooling air outlet of the power generator in communication with the inner cavity is provided; and
the inner cavity is in communication with an external environment through the third air outlet.

17. The mobile power generation apparatus according to claim 10, wherein:
an exhaust system is further arranged on the vehicle;
a gas outlet of the gas turbine in communication with the exhaust system is further provided; and
the power generator, the gas turbine, and the exhaust system are sequentially arranged.

18. The mobile power generation apparatus according to claim 17, wherein:
the exhaust system comprises a silencer, a first exhaust pipe, and a second exhaust pipe, the first exhaust pipe and the second exhaust pipe being in communication with and perpendicular to each other, the first exhaust pipe being in communication with the gas outlet, and the silencer being arranged in at least one of the first exhaust pipe and the second exhaust pipe.

19. The mobile power generation apparatus according to claim 18, wherein:
the exhaust system comprises at least two silencers, the at least two silencers being sequentially arranged and comprising a first silencer and a second silencer with a first distance therebetween;
the exhaust system comprises a first inner wall close to the first silencer with a second distance therebetween, the first inner wall being away from the second silencer;
the exhaust system further comprises a second inner wall close to the second silencer with a third distance therebetween, the second inner wall is away from the first silencer; and
at least two of the first distance, the second distance, and the third distance are different.

20. The mobile power generation apparatus according to claim 17, wherein the mobile power generation apparatus comprises a power supply module of a fracturing system, the power supply module being electrically connected to a load module of the fracturing system to supply power to the load module.
